(19) United States
(12) Patent Application Publication
(10) Pub. No.: US 2018/0287752 A1
(43) Pub. Date: Oct. 4, 2018

(54) METHOD AND APPARATUS FOR CONFIGURING TRANSPORT BLOCK TO TRANSMIT DATA

(71) Applicant: KT CORPORATION, Gyeonggi-do (KR)

(72) Inventors: Kyujin PARK, Seoul (KR); Ki-tae KIM, Seoul (KR); Woo-jin CHOI, Seoul (KR)

(73) Assignee: KT CORPORATION, Gyeonggi-do (KR)

(21) Appl. No.: 15/939,646

(22) Filed: Mar. 29, 2018

(30) Foreign Application Priority Data
Mar. 29, 2017 (KR) 10-2017-0039907
Jun. 29, 2017 (KR) 10-2017-0082407
Aug. 22, 2017 (KR) 10-2017-0106109
Dec. 22, 2017 (KR) 10-2017-0177813

(51) Int. Cl. H04L 5/00

(52) U.S. Cl. CPC H04L 5/0044; H04L 5/026

(57) ABSTRACT

Provided are a method and an apparatus for transmitting and receiving data through a next-generation radio access network (hereinafter, referred to as “New Radio (NR)”). The method of UE may include receiving information on a maximum number of Code Block Groups (CBGs) from the BS, configuring code block groups by dividing a transport block into N code blocks and grouping the N divided code blocks into M code block groups, and transmitting data through the transport block configured by the code block groups.

### CROSS REFERENCE TO RELATED APPLICATION

This application claims priority from Korean Patent Application Nos. 10-2017-0039907, 10-2017-0082407, 10-2017-0106109 & 10-2017-0177813 filed on Mar. 29, 2017, Jun. 29, 2017, Aug. 22, 2017 & Dec. 22, 2017, which are hereby incorporated by reference for all purposes as if fully set forth herein.

### BACKGROUND OF THE INVENTION

### 1. Field of the Invention

The present disclosure relates to a method and an apparatus for transmitting and receiving data through a next-generation radio access network (hereinafter, referred to as New Radio (NR)). More particularly, the present disclosure relates to operation of a user equipment and a base station that configure transport blocks to transmit and receive data.

### 2. Description of the Prior Art

3rd generation partnership project (3GPP) recently approved a “Study on New Radio Access Technology” which is a study item for research on next-generation/5G radio access technology. Radio access network working group 1 (RAN WG1) is proceeding to discussion on a frame structure, channel coding and modulation, a waveform, and a multiple-access scheme for NR based thereon. It is required to design NR to meet various requirements for respective subdivided and detailed usage scenarios, as well as an improved data transmission rate compared to long term evolution (LTE)/LTE-Advanced.

As a representative NR usage scenario, enhancement Mobile BroadBand (eMBB), massive Machine-Type Communication (mMTC), and Ultra-Reliable and Low-Latency Communications (URLLC) have been introduced. It is required to develop a frame structure design more flexible than that of LTE/LTE-Advanced to meet the requirements of each usage scenario.

As described above, to meet the requirements of the various scenarios through limited wireless resources, it is required to develop a technology of transmission/reception of high-capacity data and a fast data processing rate. Particularly, it is necessary to increase a data processing rate for the scenario that requires high-capacity data transmission and low latency, like eMBB and URLLC. To this end, it is also required to develop a new technology for the typical data transmission/reception procedure through the transport block and HARQ feedback operation.

### SUMMARY OF THE INVENTION

In this background, an aspect of the present disclosure is to provide a technology for performing a HARQ feedback and retransmission operation in shorter time units during a data transmission/reception process.

Another aspect of the present disclosure is to provide a detailed method and apparatus for configuring transport blocks to perform a HARQ feedback and retransmission operation in code block units for configuring a transport block and in code block group units.

In accordance with an aspect of the present disclosure, there is provided a method of transmitting data by a User Equipment (UE). The method includes: receiving information on a maximum number of Code Block Groups (CBGs) from a Base Station (BS); configuring code block groups by dividing a transport block into N code blocks (where N is a natural number) and grouping the N divided code blocks into M code block groups (where M is a natural number); and transmitting data through the transport block configured by the code block groups.

In accordance with another aspect of the present disclosure, there is provided a method of transmitting data by a Base Station (BS). The method includes: transmitting information on a maximum number of Code Block Groups (CBGs) to a User Equipment (UE); configuring code block groups by dividing a transport block into N code blocks (where N is a natural number) and grouping the N divided code blocks into M code block groups (where M is a natural number); and transmitting data through the transport block configured by the code block groups.

In accordance with another aspect of the present disclosure, there is provided a User Equipment (UE) for transmitting data. The UE includes: a receiver configured to receive information on a maximum number of Code Block Groups (CBGs) from a Base Station (BS); a controller configured to configure code block groups by dividing a transport block into N code blocks (where N is a natural number) and grouping the N divided code blocks into M code block groups (where M is a natural number); and a transmitter configured to transmit data through the transport block configured by the code block groups.

In accordance with another aspect of the present disclosure, there is provided a Base Station (BS) for transmitting data. The BS includes: a controller configured to configure code block groups by dividing a transport block into N code blocks (where N is a natural number) and grouping the N divided code blocks into M code block groups (where M is a natural number); and a transmitter configured to transmit information on a maximum number of Code Block Groups (CBGs) and data through a transport block configured by the code block groups to a User Equipment (UE).

According to the present embodiments, there is an effect of providing data transmission/reception through low latency by performing HARQ feedback and retransmission operation in shorter time units than that of a transport block unit.

### BRIEF DESCRIPTION OF THE DRAWINGS

The above and other aspects, features and advantages of the present disclosure will be more apparent from the following detailed description taken in conjunction with the accompanying drawings, in which:

FIG. 1 illustrates orthogonal frequency division multiplexing (OFDM) symbol arrangement when different subcarrier spacings are used according to at least one of embodiments;

FIG. 2 is a flowchart for illustrating operation of a user equipment (UE) according to an embodiment;

FIG. 3 is a diagram for illustrating configuring code block groups according to an embodiment;

FIG. 4 is a flowchart for illustrating operation of a base station (BS) according to an embodiment;

FIG. 5 is a diagram for illustrating a UE according to an embodiment; and

FIG. 6 is a diagram for illustrating a BS according to an embodiment.

### DETAILED DESCRIPTION OF THE EXEMPLARY EMBODIMENTS

Hereinafter, embodiments of the present disclosure will be described in detail with reference to the accompanying drawings. In adding reference numerals to elements in each drawing, the same elements will be designated by the same reference numerals, if possible, although they are shown in different drawings. Further, in the following description of the present disclosure, a detailed description of known functions and configurations incorporated herein will be omitted when it is determined that the description may make the subject matter of the present disclosure rather unclear.

As used herein, a wireless communication system may be a system for providing various communication services such as a voice service and a packet data service. The wireless communication system may include a User Equipment (UE) and a Base Station (BS or an eNB).

The user equipment may be a comprehensive concept that indicates a terminal for use in wireless communication, including a UE (User Equipment) in wideband code division multiple access (WCDMA), LTE, high speed packet access (HSPA), international mobile telecommunication (IMT)-2020 (5G or New Radio), and the like, and a MS (Mobile station), a UT (User Terminal), an SS (Subscriber Station), a wireless device, and the like in global system for mobile communication (GSM).

A base station or a cell may generally refer to a station where communication with a User Equipment (UE) is performed. Such a base station or cell may inclusively denote all of various coverage areas such as a Node-B, an evolved Node-B (eNB), gNode-B (gNB), Low Power Node (LPN), a Sector, a Site, various types of antennas, a Base Transceiver System (BTS), an Access Point, a Point (e.g., transmitting point, receiving point, or tranceiving point), a Relay Node, a Mega Cell, a Macro Cell, a Micro Cell, a Pico Cell, a Femto Cell, a Remote Radio Head (RRH), a Radio Unit (RU), and a Small Cell.

Each of the cells has a base station that controls a corresponding cell. Thus, the base station may be construed in two ways. 1) the base station may be a device itself that provides a megacell, a macrocell, a microcell, a picocell, a femtocell, and a small cell in association with a wireless area, or 2) the base station may indicate a wireless area itself. In 1), all devices that interact with one another to enable the devices that provide a predetermined wireless area to be controlled by an identical entity or to cooperatively configure the wireless area, may be indicated as a base station. Based on a configuration type of a wireless area, a point, a transmission/reception point, a transmission point, a reception point, or the like may be an embodiment of a base station. In ii), a wireless area itself that receives or transmits a signal from a perspective of a terminal or a neighboring base station, may be indicated as a base station.

In the present specification, a cell may refer to the coverage of a signal transmitted from a transmission/reception point, a component carrier having the coverage of the signal transmitted from the transmission/reception point (transmission point or transmission/reception point), or the transmission/reception point itself.

In the specification, the user equipment and the base station are used as two (uplink or downlink) inclusive transceiving subjects to embody the technology and technical concepts described in the specifications. However, the UE and the base station may not be limited to a predetermined term or word.

Here, Uplink (UL) refers to a scheme for a UE to transmit and receive data to/from a base station, and Downlink (DL) refers to a scheme for a base station to transmit and receive data to/from a UE.

Uplink transmission and downlink transmission may be performed using a TDD (Time Division Duplex) scheme that performs transmission based on different times. Uplink transmission and downlink transmission may also be performed using an FDD (Frequency Division Duplex) scheme that performs transmission based on different frequencies or a mixed scheme of the TDD and FDD schemes.

Further, in a wireless communication system, a standard may be developed by configuring an uplink and a downlink based on a single carrier or a pair of carriers.

The uplink and the downlink may transmit control information through a control channel, such as a PDCCH (Physical Downlink Control CHannel), PUCCH (Physical Uplink Control CHannel), and the like, and may be configured as a data channel, such as PDSCH (Physical Downlink Shared CHannel), PUSCH (Physical Uplink Shared CHannel), and the like, to transmit data.

A downlink may refer to communication or a communication path from a multi-transmission/reception point to a terminal, and an uplink may refer to communication or a communication path from a terminal to a multi-transmission/reception point. In a downlink, a transmitter may be a part of a multiple transmission/reception point and a receiver may be a part of a terminal.

In an uplink, a transmitter may be a part of a terminal and a receiver may be a part of a multiple transmission/reception point.

Hereinafter, a situation, in which signals are transmitted and received through a channel such as a PUCCH, a PUSCH, a PDCCH, or a PDSCH, will be expressed as the transmission and reception of a PUCCH, a PUSCH, a PDCCH, or a PDSCH.

Meanwhile, higher layer signaling includes an RRC signaling that transmits RRC information including an RRC parameter.

A base station performs downlink transmission to terminals. A base station may transmit a physical downlink control channel for transmitting downlink control information such as scheduling required to receive a downlink data channel that is a main physical channel for unicast transmission, and scheduling approval information for transmission on an uplink data channel. Hereinafter, transmission and reception of a signal through each channel will be described as transmission and reception of a corresponding channel.

Varied multiple access schemes may be unrestrictedly applied to the wireless communication system. Various multiple access schemes, such as TDMA (Time Division Multiple Access), FDMA (Frequency Division Multiple Access), CDMA (Code Division Multiple Access), OFDMA (Orthogonal Frequency Division Multiple Access), NOMA (Non-Orthogonal Multiple Access), OFDM-TDMA, OFDM-FDMA, OFDM-CDMA, and the like may be used. Here, NOMA includes SCMA (Sparse Code Multiple Access), LDS (Low Cost Spreading), and the like.

An embodiment of the present disclosure may be applicable to resource allocation in an asynchronous wireless communication scheme that evolves into LTE/LTE-advanced and IMT-2020 through GSM, WCDMA, and HSPA, and may be applicable to resource allocation in a synchronous wireless communication scheme that evolves into CDMA, CDMA-2000, and UMB.

In the present specifications, a machine type communication (MTC) terminal refers to a terminal that is low cost (or is not very complexity), a terminal that supports coverage enhancement, or the like. Alternatively, in the present specifications, the MTC terminal refers to a terminal that is defined as a predetermined category for maintaining low costs (or low complexity) and/or coverage enhancement.

In other words, in the present specifications, the MTC terminal may refer to a newly defined 3GPP Release 13 low cost(or low complexity) UE category/type, which executes LTE-based MTC related operations. Alternatively, in the present specifications, the MTC terminal may refer to a UE category/type that is defined in or before 3GPP Release-12 that supports the enhanced coverage in comparison with the existing LTE coverage, or supports low power consumption, or may refer to a newly defined Release 13 low cost (or low complexity) UE category/type. Alternatively, the MTC terminal may refer to a further Enhanced MTC terminal defined in Release-14.

In this specification, a NarrowBand Internet of Things (NB-IoT) User Equipment (UE) is a UE that supports radio access for cellular IoT. The purpose of NB-IoT technology is to support improved indoor coverage, large-scale low-speed UEs, low-latency sensitivity, a very low UE cost, low power consumption, and an optimized network structure.

As a representative usage scenario of New Radio (NR), which is under discussion by 3GPP, enhanced Mobile BroadBand (eMBB), massive Machine-Type Communication (mMTC), and Ultra-Reliable and Low-Latency Communication (URLLC) were suggested.

In this specification, a frequency, a frame, a subframe, resources, a resource block, a region, a band, a sub-band, a control channel, a data channel, a synchronization signal, various reference signals, various signals, and various messages that are related to NR can be interpreted as having various meanings that were used in the past or present or will be used in the future.

NR (New Radio)

3GPP recently approved a study item “Study on New Radio Access Technology” for research on a next-generation/5G radio access technology, and 3GPP has started discussing a frame structure, channel coding and modulation, a waveform and a multiple-access scheme for NR based thereon.

It is required to design NR to meet various requirements for respective subdivided and detailed usage scenarios as well as an improved data transmission rate compared to that of LTE/LTE-Advanced. Particularly, enhancement Mobile BroadBand (eMBB), massive MTC (mMTC), and Ultra-Reliable and Low-Latency Communication (URLLC) have been suggested as a representative usage scenario of NR. It is also required to design a frame structure more flexible than that of LTE/LTE-Advanced as a method of meeting requirements for respective usage scenarios.

Specifically, as representative usage scenarios of NR, 3GPP have introduced eMBB, mMTC, and URLLC. Since the respective usage scenarios have different requirements for data rates, latency, and coverage, there is need for a scheme for efficiently multiplexing radio resource units based on different numerologies (e.g. subcarrier spacing, subframe, TTI, etc.) as a method of efficiently meeting the requirements for the respective usage scenarios through frequency bands that constitute a predetermined NR system.

As a method therefor, there have been discussion on a method of multiplexing and supporting numerology having different Subcarrier Spacing (SCS) values through one NR carrier based on TDM, FDM, or TDM/FDM and a method of supporting one or more time units in configuring a scheduling unit on a time domain. In connection with this, definition of a subframe is made as one kind of a time domain structure, and it is determined to define single subframe duration that consists of 14 OFDM symbols of 15 kHz Sub-Carrier Spacing (SCS)-based normal CP overhead, which is the same as that of LTE, as reference numerology for defining the corresponding subframe duration. Accordingly, a subframe in NR has a time duration of 1 ms. However, unlike LTE, as the NR subframe is an absolute reference time duration, a slot and a mini-slot may be defined as a time unit that is the basis of actual uplink/downlink data scheduling. In this case, the number of OFDM symbols, which constitute a corresponding slot, that is, a y value, is defined as having a value of 14 regardless of numerology.

Accordingly, a predetermined slot may consist of 14 symbols. All of the symbols may be used for downlink transmission (DL transmission) or uplink transmission (UL transmission) according to the transmission direction of the corresponding slot, or the symbols may be used in the form of DL portion+(gap) +UL portion.

Further, in predetermined numerology (or SCS), a mini slot including fewer symbols than that of a corresponding slot may be defined. Based thereon, a short time-domain scheduling interval may be configured for uplink/downlink data transmission/reception, or a long time-domain scheduling interval may be configured for uplink/downlink data transmission/reception through slot aggregation.

Particularly, in the case of transmission/reception of latency-critical data like URLLC, when scheduling is performed in a slot unit of 0.5 ms (7 symbols) or 1 ms (14 symbols), defined in a frame structure based on numerology having a small SCS value, such as 15 kHz, it may be difficult to meet a latency requirement. Accordingly, a mini-slot including fewer OFDM symbols compared to the corresponding slot may be defined, and the latency-critical data may be scheduled like the corresponding URLLC based on the defined mini-slot.

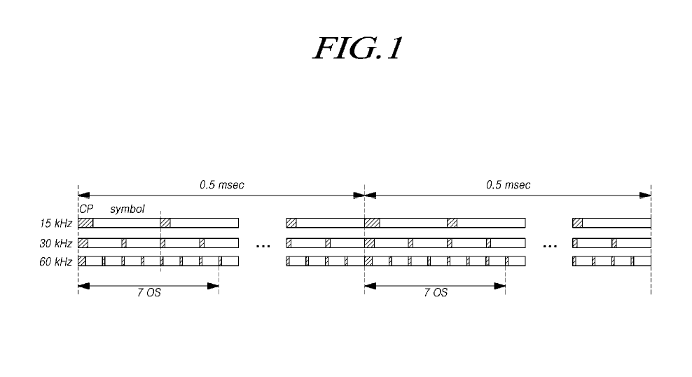

Alternatively, as described above, a method is also under consideration for supporting numerology having different SCS values by multiplexing the same using a TDM scheme or an FDM scheme in a single NR carrier, thereby scheduling data to conform to the latency requirement based on a slot (mini-slot) length defined for each numerology. For example, as shown in FIG. 1, the symbol length is reduced to ¼ in the case where SCS corresponds to 60 kHz compared to the case where SCS corresponds to 15 kHz. Accordingly, when one slot uniformly consists of 7 OFDM symbols, the corresponding slot length of 15 kHz is 0.5 ms, but the slot length of 60 kHz is reduced to about 0.125 ms.

As described above, by defining different SCSs or different TTI lengths in NR, discussion on a method of meeting each of the URLLC and the eMBB is being conducted.

Transport Block Configuration

In the LTE system, when PDSCH/PUSCH resources are allocated for predetermined LDL/UL data transmission, a Transport Block Size (TBS) for transmission through the corresponding PDSCH/PUSCH is determined based on an MCS and Resource Block (RB) allocation information. When the corresponding TBS is determined, the corresponding TB is divided (segmented) into a plurality of Code Blocks (CBs) according to a maximum CB size for encoding, encoded by attaching a CRC in the unit of corresponding CBs, and interleaved between CBs, which results in mapping for allocated PDSCH/PUSCH resources. However, HARQ ACK/NACK feedback for a predetermined PDSCH/PUSCH and a retransmission operation according thereto are performed in the unit of TBs.

In NR, since eMBB requires larger resources for the TBS compared to that of LTE, the number of CBs configuring one TB may abruptly increase according to the definition of the maximum CB size. Accordingly, it is required to further subdivide the unit of HARQ ACK/NACK feedback and retransmission for one TB, and there is need for HARQ ACK/NACK feedback and retransmission based on a Code Block Group (CBG), which is generated by grouping one or more CBs, or HARQ ACK/NACK feedback and retransmission in the unit of CBs.

In consideration of such a situation, the present disclosure proposes a technology of configuring code block groups and transmitting data when a UE and a BS transmit/receive data.

Embodiments, which will be described below, may be applied to a UE, a BS, and a core network entity (MME) that use all mobile communication technologies. For example, the present embodiments may also be applied to a next-generation mobile communication (for example, 5G mobile communication or New-RAT) UE, a BS, and a core network entity (Access and Mobility Function (AMF)) as well as a mobile communication UE to which LTE technology is applied. For convenience of description, the BS may denote an eNB of LET/E-UTRAN or a BS (a CU, a DU, or an entity implemented by one logical entity of the CU and the DU) in a 5G wireless network in which the Central Unit (CU) and the Distributed Unit (DU) are separated, that is, a gNB.

Meanwhile, in an NR usage scenario, “URLLC” refers to a service that supports high reliability and low latency, and “URLLC” may be used in the case where a serious problem occurs when a delay is generated during a data transmission/reception process although the size of transmitted/received data is not comparatively large. For example, such a URLLC service may be used for an autonomous vehicle accident that might cause serious life/property lose if the data transmission/reception becomes excessively delayed.

The eMBB may be a service using a service supporting high speed data transmission and used for transmitting and receiving a large amount of data. For example, the eMBB service may be used for a 3D video service and a UHD serviced that require transmitting a large amount of data per unit time.

The mMTC may be a service used when a size of data to be transmitted/received is not comparatively large and delay does not cause a problem but a service requiring low-power consumption. For example, the mMTC service may be used for sensor devices installed to construct a Smart City, since the sensor devices should operate in a comparatively long time with a battery.

Hereinafter, operation of a UE and a BS according to embodiments will be described with reference to the drawings.

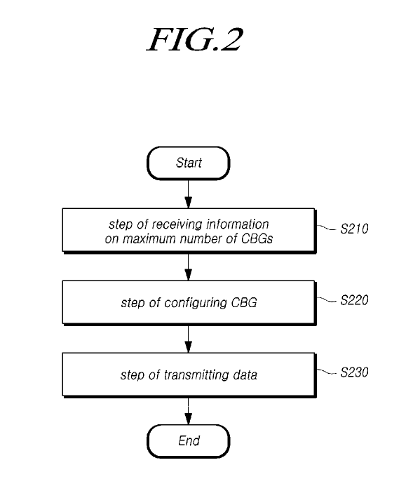

FIG. 2 is a diagram for describing operation of a UE according to an embodiment.

Referring to FIG. 2, the UE may perform a step of receiving information on the maximum number of Code Block Groups (CBGs) from the BS in S210. The information on the maximum number of code block groups includes information on the maximum number of code block groups that can be included in one transport block as the UE divides a transport block into a plurality of code blocks and configures one or more code blocks into code block groups.

The information on the maximum number of code block groups may be received through UE-specific higher-layer signaling or cell-specific higher-layer signaling. For example, the information on the number of maximum code block groups may be UE-specifically or cell-specifically received through RRC signaling.

The UE may generate a code block group by i) dividing a transport block into N code blocks (where N is a natural number) and ii) grouping the N divided code blocks into M code block groups (where M is a natural number) in S220. For example, the UE may divide one transport block, which is configured for data transmission, into N code blocks. Thereafter, the UE may configure code block groups by grouping the N divided code blocks into M code block groups.

For example, the number of code block groups M may be determined based on a smaller value between the maximum number of code block groups and the number of code blocks N. Specifically, the UE may select the smaller value between the maximum number of code block groups received from the BS and the number of code blocks N into which the transport block is divided, and the UE may determine a number of code block groups that is equal to or smaller than the selected value. For example, when 3 is received as the maximum number of code block groups and when the number of divided code blocks is 10, the UE may select, as the number of code block groups, one of the natural numbers that are equal to or smaller than 3. That is, one of 1, 2, and 3 may be determined as the number of code block groups.

For another example, the UE may determine the number of code blocks in each code block group based on a value obtained by dividing the number of code blocks by the number of code block groups. For example, when the number of code block groups is determined through the above-described method, the UE may determine the number of code blocks included in each code block group based on the value obtained by dividing the number (N) of divided code blocks by the number (M) of determined code block groups.

For example, when there are M code block groups, the number of code blocks of one code block group in first K code block groups may be determined based on code block group indexes by i) dividing the number of code blocks by the number of code block groups, ii) rounding up the division result, and iii) determining the rounding-up result as the number of code blocks in each code block group of first K code blocks. When the number N of code blocks is 10 and the number M of code block groups is determined as 3, the UE determines the number of code blocks in one code block group as 4. The UE may perform grouping by including 4 code blocks in first K code block groups based on code block group indexes. For example, 4 may be a value determined using the equation ceil (N/M).

The number of code blocks of one code block group in the remaining code block groups (M−K code block groups) among total M code block groups is determined by i) dividing the number of code block by the number of code block groups, ii) rounding off the division result, and iii) determining the rounding-off result as the number of code blocks of one code block group in the remaining code block groups. When the number N of code blocks is 10 and the number M of code block groups is 3, the UE may determine the number of code blocks of one code block group in the remaining code blocks is 3. The UE may perform grouping by including 3 code blocks in the remaining M−K code block groups other than K code block groups based on the above-described code block group indexes. For example, 3 may be a value determined using the equation floor (N/<M).

Meanwhile, K in the above embodiments is determined as a remainder obtained by dividing the number N of code blocks by the number M of code block groups. For example, when N is 10 and M is 3, K may be determined to be 1.

That is, when the number of code blocks is 10 and the number of code block groups is 3, the UE may perform including 4 code blocks in 1 code block group based on code block group indexes and including 3 code blocks in the remaining 2 code block groups. That is, the code blocks may be grouped by including 4 code blocks in code block group index 0 and including 3 code blocks in each of code block group indexes 1 and 2.

Meanwhile, when the number of code blocks to be included in each code block group is determined, the UE determines code blocks and code block groups to include the code blocks.

For example, based on code block group indexes and the number of code blocks per code block group, the controller 510 may allocate N code blocks to M code block groups and group the N code blocks according to the order of the code block indexes. Specifically, when 10 code blocks are grouped into 3 code block groups, the UE groups sequentially include the code blocks in the code block groups according to the order of code block indexes.

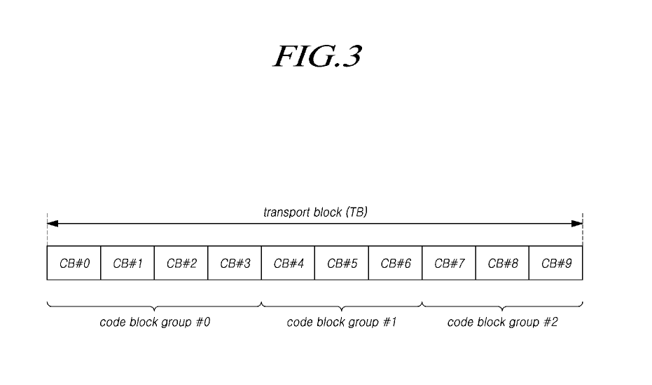

Referring to FIG. 3, code block indexes CB#0 to CB#3 are groups to be included in code block group #0, code block indexes CB#4 to CB#6 are grouped to be included in code block group #1, and code block indexes CB#7 to CB#9 are grouped to be included in code block group #2.

Through the above operation, the UE may divide a transport block into a plurality of code blocks and group the divided code blocks into each code block group according to the above-described embodiment.

The UE may perform a step of transmitting data through a transport block configured by code block groups in S230. For example, the UE attaches a CRC to each code block, groups the code blocks into code block groups, and transmit a transport block. The BS may control the performance of a HARQ operation and a retransmission operation in code block group units.

Accordingly, even though the transport block is configured to be long on a time axis, fast data processing is possible since a HARQ operation and a retransmission operation are performed in code block group units.

Hereinafter, operation of a BS for transmitting downlink data to the UE will be described.

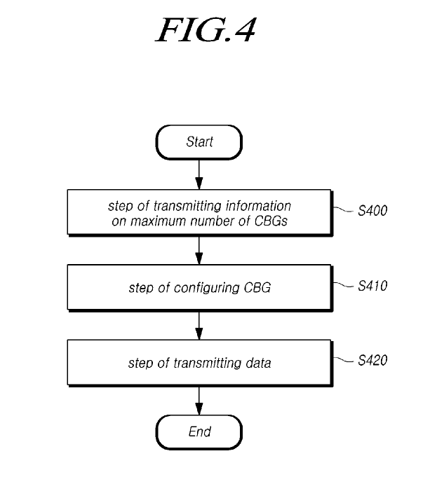

FIG. 4 is a flowchart for describing operation of a BS according to an embodiment.

Referring to FIG. 4, the BS may perform a step of transmitting information on the maximum number of Code Block Groups (CBGs) to the UE in S400. The BS may transmit information on the maximum number of code block groups determined according to a predetermined criterion to the UE. For example, the information on the maximum number of code block groups may be transmitted through UE-specific higher-layer signaling or cell-specific higher-layer signaling.

The BS may perform a step of dividing a transport block into N code blocks (where N is a natural number) and grouping the N divided code blocks into M code block groups (where M is a natural number) to configure code block groups in S410.

As described above, the BS may determine the number of code block groups M based on a smaller one between the maximum number of code block groups and the number of code blocks N. For example, the BS may select the smaller one between the configured maximum number of code block groups and the number of code blocks N into which the transport block is divided and determine the number of code block groups to be equal to or smaller than the selected value. That is, when the maximum number of code block groups is configured as 3 and the number of divided code blocks is 10, the BS may select the number of code block groups to be a natural number equal to or smaller than 3. Accordingly, the number of code block groups may be one of 1, 2, and 3.

Further, the BS may determine the number of code blocks per code block group included in each code block group based on a value obtained by dividing the number of code blocks by the number of code block groups. For example, when the number of code block groups is determined through the above-described method, the BS may determine the number of code blocks included in each code block group based on a value obtained by dividing the number (N) of divided code blocks by the number (M) of determined code block groups.

For example, the number of code blocks of one code block group in first K code block groups among M code block groups may be determined based on a code block group index by i) dividing the number of code blocks by the number of code block groups, ii) rounding up the division result, and iii) determining the rounding-up result as the number of code blocks. When the number N of code blocks is 10 and the number M of code block groups is 3, the UE may determine 4 as the number of code blocks in one code block group of the first K code block groups among the M code block groups. That is, the UE may include 4 code blocks in each code block group of the first K code block groups based on code block group indexes. For example, 4 may be a value determined using the equation ceil (N/M).

The number of code blocks of one code block group in the remaining code block groups (M−K code block groups) among the M code block groups may be determined by i) dividing the number of code blocks by the number of code block groups, ii) rounding off the division result, and iii) determining the rounding-off result as the number of code blocks in one block group of the remaining code bloc groups. When the number N of code blocks is 10 and the number M of code block groups is determined 3, the BS may determine 3 as the number of code blocks in one code block group and include 3 code blocks in each code block group of the remaining M−K code block groups based on the above-described code block group indexes. That is, 3 may be a value determined using the equation floor (N/M).

As described above, K is determined as a remainder obtained by dividing N, which is the number N of code blocks, by M, which is the number of code block groups. For example, when N is 10 and M is 3, K may be determined to be 1.

Further, based on code block group indexes and the number of code blocks of each code block group, the BS may allocate N code blocks to M code block groups according to the order of the code block indexes to group the code blocks. Specifically, when 10 code blocks are to be grouped into 3 code block groups, the BS groups the code blocks to be sequentially included in the code block groups according to the order of the code block indexes. That is, as shown in FIG. 3, the code blocks may be included in each code block according to the order of indexes.

The BS may perform a step of transmitting data through a transport block configured by code block groups in S420. The BS may transmit downlink data to the UE through the transport block that has been divided into respective code blocks grouped into code block groups based on the above-described criterion.

Hereinafter, various embodiments in which the UE or the BS configures and transmits code block groups to transmit uplink data or downlink data will be described based on each operation step of the UE and the BS.

Embodiment of Configuring a Number of Code Block Groups (CBGs)

A number of CBGs for configuring a predetermined transport block may be dynamically signaled through Downlink Control Information (CDI), or such a number of CBGs may be implicitly set. For example, the number of CBGs for a to predetermined UE may be transmitted through a PDCCH while being included in a DL assignment DCI or a UL grant DCI for transmitting resource allocation information on a PDSCH or a PUSCH.

Alternatively, the number of CBGs may be determined by a function of the TBS transmitted through a predetermined PDSCH or PUSCH or a function of a number of CBs determined by the TBS and the maximum Code Block (CB) size.

Alternatively, the size of the corresponding CBG may be determined according to mini slots for configuring a predetermined slot or a number of mini-slot groups.

Alternatively, the CBGs may be semi-statically set for each UE through UE-specific or cell-specific higher-layer signaling.

Alternatively, the CBGs may be determined by a function of a number of CBGs set through UE-specific or cell-specific higher-layer signaling or L1 signaling through a DCI or a number of CBs for configuring a TB transmitted through a predetermined PDSCH or PUSCH. For example, the CBGs for configuring the corresponding TB may be determined based on the smaller or the same value between i) the number of CBGs (for example, the maximum number of CBGs) set through UE-specific or cell-specific higher-layer signaling or L1 signaling and ii) the number of CBs for actually configuring the corresponding TB. That is, when one PDSCH or PUSCH is transmitted to each UE through UE-specific or cell-specific higher-layer signaling or L1 signaling, the BS may indicate the maximum number of code block groups that can be configured for one TB transmitted through the corresponding PDSCH or PUSCH. In this case, the number of actually configured CBGs may be set as the smaller or the same value between the number of CBs for configuring the corresponding TB and the maximum number of code block groups set by the BS.

Alternatively, the number and configuration of CBGs for a predetermined TB may be performed through a combination of parameters transmitted through UE-specific or cell-specific higher-layer signaling and parameters transmitted through L1 control signaling, such as a DL assignment DCI or a UL grant. Specifically, when the BS sets a CBG reference transmission or retransmission operation for a predetermined UE through UE-specific or cell-specific higher-layer signaling, the BS may perform definition to set the size of a CBB indication information region (that is, a number of bits for configuring the corresponding CBG indication information region) to be included in the DL assignment DCI or UL grant for the corresponding UE. Further, the BS may perform definition to set, through the corresponding CBG indication information region, the number of CBGs for the TB transmitted/received through the PDSCH or PUSCH allocated through the corresponding DL assignment DCI or UL grant. For example, when CBG-based PDSCH or PUSCH transmission or retransmission for a predetermined UE is set by the BS, the CBG indication information region configured through the DL assignment DCI or UL grant for the corresponding UE may be a bitmap information region for indicating CBGs transmitted through PDSCH or PUSCH transmission resources allocated through the corresponding DL assignment DCI or UL grant. Accordingly, the BS sets the size of the bitmap information region (that is, the number of bits for configuring the bitmap information region indicating the corresponding CBGs) indicating the corresponding CBGs to be included in the DL assignment DCI or UL grant for a predetermined UE. Accordingly, the size of the bitmap of the CBG indication information region included in the DL assignment DCI or UL grant for the corresponding UE is determined. However, when a CBG-based transmission or retransmission operation for the PDSCH of a predetermined UE is set by the BS, the size of HARQ ACK/NACK feedback information (for example, the number of HARQ ACK/NACK feedback bits) through the PUCCH or the PUSCH of the corresponding UE may be determined according to the size of the bitmap of the CGB indication information region set through corresponding UE-specific or cell-specific higher-layer signaling. As described above, when the CBG-based PDSCH or PUSCH transmission or retransmission for a predetermined UE is set and the size of the CBG indication information region of the DL assignment DCI or UL grant for the corresponding UE is set by the BS, in PDSCH or PUSCH transmission for the corresponding UE, the number of CBGs for configuring the TB transmitted through the corresponding PDSCH or PUSCH may be indicated through the CGB indication information region of the DL assignment DCI or UL grant for transmitting transmission resource allocation information for initial transmission of the corresponding PDSCH or PUSCH. For example, as described above, when the CBG indication information region included in the DL assignment DCI or UL grant is configured in the form of a bitmap for indicating the CBG transmitted through the PDSCH or the PUSCH allocated through the corresponding DL assignment DCI or UL grant, in initial PDSCH or initial PUSCH resource allocation for transmission or a predetermined TB, the number of CBGs for configuring the corresponding TB may be implicitly indicated through the bitmap-based CBG indication information region included in the corresponding DL assignment DCI or UL grant. Specifically, when the BS configures the bitmap information region for indicating the corresponding CBG, the CBG transmitted through the PDSCH or the PUSCH allocated by the corresponding DL assignment DCI or UL grant may be indicated by “1”. When the CBG, which has not been transmitted, is defined to be indicated by “0”, in the configuration of the bitmap for indicating the CBG of the DL assignment DCI or UL grant including initial PDSCH or PUSCH resource allocation information for predetermined TB transmission, bits in the bitmap for indicating the CBG, which correspond to the number of CBGs for the corresponding TB, may be configured as “1” from the LSB or MSB, and the remaining bit(s) may be configured as “0” and transmitted.

As described above, through various embodiments, the number of code block groups included in one transport block may be determined.

Code Block Grouping Method

When the number of code block groups is determined, an operation of grouping the code blocks into code block groups should be performed. To this end, various grouping methods may be applied. Hereinafter, embodiments are classified according to the order in which the transport block is divided, and a more detailed code block grouping example will be described in connection with each embodiment.

Method of First Dividing a Code Block Group (CBG)

A predetermined TB is primarily divided at a CBG level, and then a CB is divided within the corresponding CBG. That is, when the number of CBGs is determined according to various methods, the corresponding TB may be configured as evenly divided or almost evenly divided CBGs according to the number of corresponding CBGs. When the evenly or almost evenly divided CBGs are configured for the TB of a predetermined PDSCH or PUSCH, code blocks may be independently configured according to the maximum CB size within each CBG. When the independent CBs are configured at the CBG level, mapping may be performed within allocated PDSCH or PUSCH resources, with or without interleaving of CBs within each CGB. Alternatively, interleaving or no interleaving may be set through UE-specific or cell-specific higher-layer signaling or L1 control signaling by the BS.

Method of First Dividing a Code Block (CB)

A predetermined TB transmitted through a predetermined PDSCH or PUSCH may be primarily divided into evenly divided CBs or almost evenly divided CBs according to the maximum CB size, and the divided CBs may be grouped by being sequentially mapped to CBGs according to the number of set CBGs.

For example, when N CBs (CB #0 to CB #(N−1)) are configured to a predetermined TB and when M CBGs are set for the corresponding TB, CBs included in each of CBG #0 to CBG #(M−1) may be configured by applying equation (1) below. That is, predetermined CBG #m (however, m=0, . . . , M−1) is configured by CB #n that meets equation (1).

$$n = m + i \cdot M , \{ \begin{matrix}i = 0 , … , [ N / M ] & when , m < ( N mod M ) \\ i = 0 , … , [ N / M ] - 1 & when , m >= ( N mod M )\end{matrix} \qquad Equation ( 1 )$$

However, [X] is a maximum integer that is not larger than X. That is, [X] is a maximum integer among integers which are equal to or smaller than X (for example, a floor function). However, according to equation (1), in the determination of CBs that configure each CBG, one of CBs #0 to #(N−1) is cyclically mapped to each of CBGs #0 to #(M−1), but the embodiment is not limited to the form of the corresponding equation. That is, all cases where CBs are sequentially mapped to each CBG in increasing order of CB index are included in the present embodiment.

More specifically, when N=10 and M=3, CBs may be sequentially/cyclically mapped to CBGs in increasing order of CB index such that CBG #0={#0, 3, 6, 9}, CBG #1={CB #1, 4, 7}, and CBG #2={CB #2, 5, 8}.

For another example, in the configuration of M CBGs, first K CBGs are configured by ceil (N/M) CB(s) and the remaining (M−K) CBGs are configured by floor (N/M) CB(s). However, in this case, K=N mod M. Accordingly, among a total of M CBGs, first K CBGs may be configured by sequentially grouping ceil (N/M) CBs with respect to a total of K ceil (N/M) CBs from CB #0 to CB #(K·ceil (N/M)−1), and the remaining (M−K) CBGs may be configured by sequentially grouping floor (N/M) CB(s) with respect to a total of (M−K)·floor (N/M) CB(s) from CB #(K·ceil (N/M)) to CB #(N−1). That is, as described above, when N=10, and M=3, CBG #0={CB #0, 1, 2, 3}, CBG #1={CB #4, 5, 6}, and CFG #2={CB #7, 8, 9}.

In another example, a method of mapping CBs that configure a predetermined CBG may be performed by equation (2) below. That is, predetermined CBG #m (however, m=0, . . . , M−1) is configured by CB #n that meets equation (2).

$$n = m \cdot [ N / M ] + i , \{ \begin{matrix}i = 0 , … , [ N / M ] - 1 & when , m < M - ( N mod M ) \\ i = 0 , … , [ N / M ] & when , m >= M - ( N mod M )\end{matrix} \qquad Equation ( 2 )$$

However, according to equation (2), in the configuration of each CBG, each CGB is sequentially configured by [N/M] successive CBs, and the last CBG is configured by the remaining CBs. That is, CBGs from CBG #0 to CBG #(M−2) are configured by [N/M] successive CBs in such a manner that CBG #0 is configured by [N/M] CBs from CB #0 to CB #[N/M]−1, CBG #1 is configured by the following [N/M] CBs from CB #[N/M] to CB #2[N/M]−1 and the last CBG #(M−1) is configured by the remaining CBs.

For another example, a method of configuring CBs in the reverse form of equations (1) and (2) (that is, sequentially from the highest CBG index) may be applied.

In the above-described embodiments, interleaving between CBs for PDSCH/PUSCH resource mapping may be performed in the unit of CBGs or TBs, or localized mapping may be applied without applying interleaving. Alternatively, whether to apply corresponding interleaving and a CBG-based or TB-based interleaving mode may be set to the BS through UE-specific or cell-specific higher-layer signaling or L1 control signaling.

Method of Mapping PDSCH/PUSCH Resources

Embodiment of CBG-Specific Resource Mapping

In a method of mapping the TB, which is to be transmitted, to allocated PDSCH/PUSCH resources, resource mapping and rate matching may be set to be performed for each CBG that configures the corresponding TB. That is, in the corresponding PDSCH or PUSCH resource mapping, allocated PDSCH or PUSCH resources may be divided according to the number of CBGs and resource mapping, and rate matching may be performed for each CBG within the corresponding divided PDSCH or PUSCH resources.

At this time, the corresponding resource division may be set to be performed on a time domain. That is, with respect to a Transmission Time Interval (TTI), at which the PDSCH or PUSCH transmission is performed, resource mapping may be set to be performed in the unit of evenly or almost evenly divided symbols (or symbol groups, mini slots, mini slot groups, slots, or slot groups) according to the number of CBGs.

Alternatively, the corresponding resource division may be performed on a frequency domain. That is, the allocated Physical Resource Block (PRB) resources may be divided into evenly or almost evenly divided sub-bands, and then resource mapping and rate matching may be performed for each CBG within the corresponding sub-band. At this time, the resource mapping for each CGB within the corresponding divided region may be performed in a frequency-first manner or a time-first manner. However, in addition, the frequency-first manner or the time-first manner mapping may be set by the BS through an L1 control signal (for example, a DL assignment DCI or a UL grant DCI) or UE-specific or cell-specific higher-layer signaling.

Embodiment of TB-Specific Resource Mapping

Resource mapping and rate matching for transmission resources that configure the PDSCH or PUSCH allocated in the unit of TBs may be performed. That is, regardless of the number of CBs or CBGs that configure a predetermined TB, a consistent resource mapping and rate matching method for PDSCH/PUSCH resources allocated for corresponding TB transmission may be applied.

Further, in the above-described CBG grouping method and resource mapping/rate matching method, a CBG grouping method or a resource mapping/rate matching method, which the BS applies to each UE, may be set. In this case, the corresponding CBG grouping method and resource mapping/rate matching method may be independently set through separate information regions, or the corresponding CBG grouping method and resource mapping/rate matching method may be jointly set through one information region. In addition, the corresponding setting may be semi-statically performed for transmission through UE-specific or cell-specific higher-layer signaling, or the corresponding setting may be dynamically performed for transmission through an L1 control signal (for example, a DL assignment DCI or a UL grant DCI).

Embodiments of the steps described above may be independently applied, or all or some thereof may be combined with each other and applied.

Hereinafter, a UE and a BS according to embodiments will be described with reference to the drawings.

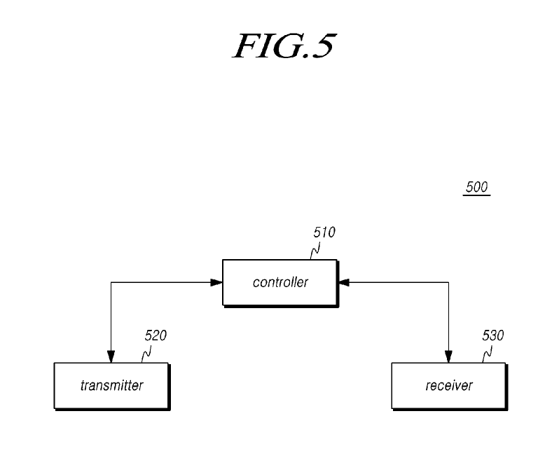

FIG. 5 illustrates a UE according to an embodiment.

Referring to FIG. 5, a UE 500 for transmitting data may include a receiver 530 for receiving information on the maximum number of Code Block Groups (CBGs) from a BS, a controller 510 for dividing a transport block into N code blocks (where N is a natural number) and grouping the N divided code blocks into M code block groups (where M is a natural number) to configure code block groups, and a transmitter 520 for transmitting data through the transport block that has been configured to be the code block groups.

The receiver 520 may receive information on the maximum number of code block groups through UE-specific higher-layer signaling or cell-specific higher-layer signaling. For example, the information on the maximum number of code block groups may be UE-specifically or cell-specifically received through RRC signaling. In addition, the receiver 510 may receive downlink control information, data, and messages through a corresponding channel from the BS.

The controller 510 may divide one transport block configured for data transmission into N code blocks and group the N divided code blocks into M code block groups to configure the code block groups. For example, the number of code block groups M may be determined based on the smaller value between the maximum number of code block groups and the number of code blocks N. Specifically, the controller 510 may select the smaller value between the maximum number of code block groups received from the BS and the number of code blocks N into which the transport block is divided, and the controller 510 may determine the number of code block groups to be smaller than or equal to the selected value. In another example, the controller 510 may determine the number of code blocks included in each code block group based on a value obtained by dividing the number of code blocks by the number of code block groups. For example, when the number of code block groups is determined through the above-described method, the controller 510 may determine the number of code blocks included in each code block group using a value obtained by dividing the number (N) of divided code blocks by the determined number (M) of code block groups.

Specifically, the controller 510 may i) divide the number of code blocks by the number of code block groups, ii) round up the division result, and iii) determine the rounding-up result as the number of code blocks of each code block group in first K code block groups among M code block groups based on a code block group index. Then, the controller 510 may iv) divide the number of code blocks by the number of code block groups, v) round off the division result, and vi) determine the rounding-off result as the number of code blocks of one code block group in the remaining code block groups (M−K code block groups) among the M code block groups. Meanwhile, K is determined as a remainder obtained by dividing the number N of code blocks by the number M of code block groups. For example, when N is 10 and M is 3, K may be determined to be 1.

Further, when the number of code blocks to be included in each code block group is determined, the controller 510 determines code blocks and a code block group into which to group the determined code blocks. For example, based on code block group indexes and the number of code blocks per code block group, the controller 510 may allocate N code blocks to M code block groups and group the N code blocks according to the order of the code block indexes. Specifically, when 10 code blocks are grouped into 3 code block groups, the controller 510 performs grouping to sequentially include the code blocks in the code block groups according to the order of the code block indexes.

Further, the controller 510 controls the overall operation of the UE 500 according to the configuration of transport blocks into one or more code block groups to transmit data according to the above-described present embodiments.

The transmitter 530 attaches a CRC to each code block, groups the code blocks into code block groups, and transmits a transport block to the BS. Further, the transmitter 530 transmits uplink control information, data, and messages to the BS through a corresponding channel.

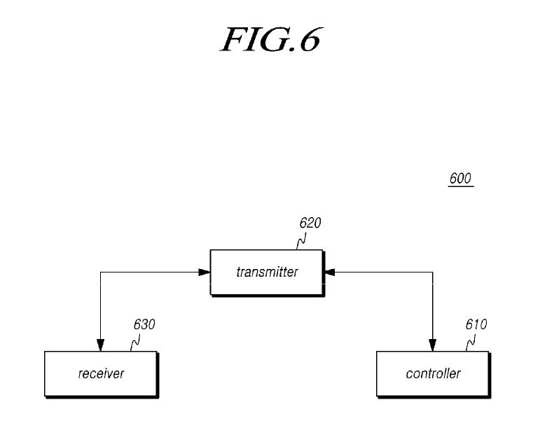

FIG. 6 illustrates a BS according to an embodiment.

Referring to FIG. 6, a UE 600 for transmitting data may include a controller 610 for dividing a transport block into N code blocks (where N is a natural number) and grouping the N divided code blocks into M code block groups (where M is a natural number) to configure code block groups, and a transmitter 620 for transmitting information on the maximum number of Code Block Groups (CBGs) and data through the transport block that has been configured to be the code block groups to the UE.

The controller 610 may determine the M number of code block groups based on the smaller number between the maximum number of code block groups and the number of code blocks N. For example, the controller 610 may select the smaller value between the configured maximum number of code block groups and the number of code blocks N into which the transport block is divided and determine the number of code block groups to be a value smaller than or equal to the selected value. That is, when the maximum number of code block groups is configured as 3 and the number of divided code blocks is 10, the controller 610 may select the number of code block groups to be one of the natural numbers to equal to or smaller than 3. Accordingly, the number of code block groups may be one of 1, 2, and 3.

Further, the controller 610 may determine the number of code blocks per code block group included in each code block group based on a value obtained by dividing the number of code blocks by the number of code block groups. For example, when the number of code block groups is determined through the above-described method, the controller 610 may determine the number of code blocks included in each code block group using a value obtained by dividing the number (N) of divided code blocks by the determined number (M) of code block groups. For example, the controller 610 may i) divide the number of code blocks by the number of code block groups, ii) round up the division result, and iii) determine the rounding-up result as the number of code blocks of one code block group in first K code block groups based on a code block group index among M code block groups. Then, the controller 610 may i) divide the number of code blocks by the number of code block groups, ii) round off the division result, and iii) determine the rounding-off result as the number of code blocks of one code block group in the remaining code block groups among the M code block groups. As described above, K is determined as a remainder obtained by dividing N, which is the number N of code blocks, by M, which is the number of code block groups.

The controller 610 may allocate N code blocks to M code block groups based on code block group indexes and the number of code blocks of each code block group according to the order of the code block indexes to group the code blocks. Specifically, when 10 code blocks are to be grouped into 3 code block groups, the BS groups the code blocks to be sequentially included in the code block groups according to the order of the code block indexes.

In addition, the controller 610 controls the overall operation of the BS 600 in which the BS configures a transport block to be one or more code block groups to transmit data according to the present embodiments.

Meanwhile, the transmitter 620 may transmit downlink data to the UE through the transport block that has been divided into respective code blocks grouped into code block groups based on the above-described criterion. Further, the transmitter 620 may transmit information on the maximum number of Code Block Groups (CBGs) to the UE through UE-specific higher-layer signaling or cell-specific higher-layer signaling.

In addition, the transmitting unit 620 and the receiving unit 630 may be used for transmitting and receiving, to/from a terminal, a signal or a message and data required to implement the above described present disclosure.

The standard details or standard documents mentioned in the above embodiments are omitted for the simplicity of the description of the specification, and constitute a part of the present specification. Therefore, when a part of the contents of the standard details and the standard documents is added to the present specifications or is disclosed in the claims, it should be construed as falling within the scope of the present disclosure.

The above embodiments of the present disclosure have been described only for illustrative purposes, and those skilled in the art will appreciate that various modifications and changes may be made thereto without departing from the scope and spirit of the disclosure. Therefore, the embodiments of the present disclosure are not intended to limit, but are intended to illustrate the technical idea of the present disclosure, and the scope of the technical idea of the present disclosure is not limited by the embodiments. The scope of the present disclosure shall be construed on the basis of the accompanying claims in such a manner that all of the technical ideas included within the scope equivalent to the claims belong to the present disclosure.

Moreover, the terms “system,” “processor,” “controller,” “component,” “module,” “interface,”, “model,” “unit” or the like are generally intended to refer to a computer-related entity, either hardware, a combination of hardware and software, software, or software in execution. For example, a component may be, but is not limited to being, a process running on a processor, a processor, a controller, a control processor, an object, an executable, a thread of execution, a program, and/or a computer. By way of illustration, both an application running on a controller or processor and the controller or processor can be a component. One or more components may reside within a process and/or thread of execution and a component may be localized on one computer and/or distributed between two or more computers.

What is claimed is:

1. A method of transmitting data by a User Equipment (UE), the method comprising:
receiving information on a maximum number of Code Block Groups (CBGs) from a Base Station (BS);
configuring code block groups by dividing a transport block into N code blocks and grouping the N divided code blocks into M code block groups, where N and M are a natural number; and
transmitting data through the transport block configured by the code block groups.

2. The method of claim 1, wherein the information on the maximum number of code block groups is received through at least one of UE-specific higher-layer signaling and cell-specific higher-layer signaling.

3. The method of claim 1, wherein the number of code block groups M is determined based on a smaller value between the maximum number of code block groups and the number of code blocks N.

4. The method of claim 1, wherein the configuring the code block groups comprises determining a number of code blocks per code block group based on a value obtained by dividing the number of code blocks by the number of code block groups.

5. The method of claim 4, wherein the number of code blocks per code block group in first K code block groups based on code block group indexes among the M code block groups is determined as a value obtained by i) dividing the number of code blocks by the number of code block groups and ii) rounding up the division result,
the number of code blocks per code block group in the remaining code block groups other than the K code block groups among the M code block groups is determined as a value obtained by iii) dividing the number of code blocks by the number of code block groups and iv) rounding off the division result, and
K is determined according to a remainder obtained by dividing N by M.

6. The method of 4, wherein the configuring of the code block groups comprises grouping the code block groups by allocating the N code blocks to the M code block groups based on code block group indexes and the number of code blocks per code block group according to the order of code block indexes.

7. A method of transmitting data by a Base Station (BS), the method comprising:
transmitting information on a maximum number of Code Block Groups (CBGs) to a User Equipment (UE);
configuring code block groups by dividing a transport block into N code blocks and grouping the N divided code blocks into M code block groups, where N and M are a natural number; and
transmitting data through the transport block configured by the code block groups.

8. The method of claim 7, wherein the information on the maximum number of code block groups is transmitted through at least one of UE-specific higher-layer signaling and cell-specific higher-layer signaling.

9. The method of claim 7, wherein the number of code block groups M is determined based on a smaller value between the maximum number of code block groups and the number of code blocks N.

10. The method of claim 7, wherein the configuring the code block groups comprises determining a number of code blocks per code block group based on a value obtained by dividing the number of code blocks by the number of code block groups.

11. The method of claim 10, wherein the number of code blocks per code block group in first K code block groups based on code block group indexes among the M code block groups is determined as a value obtained by i) dividing the number of code blocks by the number of code block groups and ii) rounding up the division result,
the number of code blocks per code block group included in each of the remaining code block groups other than the K code block groups among the M code block groups is determined as a value obtained by iii) dividing the number of code blocks by the number of code block groups and iv) rounding off the division result, and
K is determined according to a remainder obtained by dividing N by M.

12. The method of 10, wherein the configuring of the code block groups comprises grouping the code block groups by allocating the N code blocks to the M code block groups based on code block group indexes and the number of code blocks per code block group according to the order of code block indexes.

13. A User Equipment (UE) for transmitting data, the UE comprising:
a receiver configured to receive information on a maximum number of Code Block Groups (CBGs) from a Base Station (BS);
a controller configured to configure code block groups by dividing a transport block into N code blocks and grouping the N divided code blocks into M code block groups, where N and M are a natural number); and
a transmitter configured to transmit data through the transport block configured by the code block groups.

14. The UE of claim 13, wherein the information on the maximum number of code block groups is received through one of UE-specific higher-layer signaling and cell-specific higher-layer signaling.

15. The UE of claim 13, wherein the number of code block groups M is determined based on a smaller value between the maximum number of code block groups and the number of code blocks N.

16. The UE of claim 13, wherein the controller determines a number of code blocks per code block group included in each code block group based on a value obtained by dividing the number of code blocks by the number of code block groups.

17. The UE of claim 16, wherein the number of code blocks per code block group in first K code block groups based on code block group indexes among the M code block groups is determined as a value obtained by i) dividing the number of code blocks by the number of code block groups and ii) rounding up the division result,
the number of code blocks per code block group in the remaining code block groups other than the K code block groups among the M code block groups is determined as a value obtained by i) dividing the number of code blocks by the number of code block groups and ii) rounding off the division result, and
K is determined according to a remainder obtained by dividing N by M.

18. The UE of claim 16, wherein the controller groups the code block groups by allocating the N code blocks to the M code block groups based on code block group indexes and the number of code blocks per code block group according to the order of code block indexes.
